(19) United States
(12) Patent Application Publication
(10) Pub. No.: US 2023/0312986 A1
(43) Pub. Date: Oct. 5, 2023

(54) RECYCLABLE LABELS

(71) Applicant: Multi-Color Corporation, Batavia, OH (US)

(72) Inventors: Noel Glenn Stewart, Cumming, GA (US); Ryan Zarbaugh, Monroe, OH (US)

(21) Appl. No.: 18/194,268

(22) Filed: Mar. 31, 2023

Related U.S. Application Data
(60) Provisional application No. 63/362,348, filed on Apr. 1, 2022.

(51) Int. Cl. C09J 7/29; C09J 7/38; B32B 27/36; B32B 7/12

(52) U.S. Cl. CPC C09J 7/29; C09J 7/38; B32B 27/36; B32B 7/12; C09J 2203/334; C09J 2301/302; C09J 2467/006; C09J 2433/003; B32B 27/08

(57) ABSTRACT

A wrap-around label configured to be affixed to an article made of polyethylene terephthalate (PET) and collected as recycled PET. The wrap-around label may further include a washable ink that is configured to be removed prior to collection of the wrap-around label as recycled PET. The wrap-around label may also include an adhesive that is configured to dissolve or disperse in a caustic bath. In some embodiments, the wrap-around label may function as a pressure-sensitive label (PSL). A method for preparing a wrap-around label that is configured to be affixed to an article made of PET and collected as recycled PET.

### FIELD OF THE INVENTION

The present invention generally relates to labels, and more particularly to labels that provide enhanced recyclability and/or enhanced recycling compatibility.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

The concept of affixing a label to an article is old and well known. Certain labels typically may include a label substrate and one or more inks and adhesives. The labels typically include decoration (such as visible graphics, text, and/or other indicia). One type of article that labels are affixed to is an article made of polyethylene terephthalate (PET). Various kinds of articles made of PET to which such labels may be affixed include, but are not limited to, drinking bottles, microwaveable trays, and food containers.

One problem that arises with affixing labels to articles is that, when companies attempt to recycle the article, the label is often still affixed to the article. And so, the label must be separated from the article prior to moving the article into a recycled materials stream (or as an initial step in such a recycled materials stream). In keeping with the example discussed above, articles may be made of PET. Examples of label materials that are conventionally removed from articles made of PET prior to collection of recycled PET include, but are not limited to, polypropylene (PP), biaxially oriented polypropylene (BOPP), polyvinyl chloride (PVC), glycol modified PET (PETG), paper, or some combination thereof. Conventional methods of removing a label from articles made of PET include, but are not limited to, subjecting the labelled article to a caustic bath or to grinding.

In some recycling systems, materials that cannot be collected as recycled PET, such as the labels described above, are removed and separated from the article made of PET based on a difference in specific gravity. This removal and separation based on specific gravity may be implemented using a sink-float system, such as a conventional hot caustic bath sink-float system. In such a system, materials with a specific gravity less than 1.0, such as the polypropylene conventional labels described above, float to the top of a caustic bath, while materials with a specific gravity greater than 1.0, such as PET, sink to the bottom of the caustic bath. Once the dense materials sink to the bottom of the caustic bath, the materials may be shredded into small pieces (flakes) and subsequently collected as recycled PET. In some hot caustic bath sink-float systems, the article is shredded while the label before the label is removed. The light materials that float to the top are skimmed off of the surface and collected to determine whether recycling of those skimmed materials is reasonably possible. If several different types of materials float to the top of the hot caustic bath, then the resulting mixture of materials must be separated into individual components before recycling is possible. In many such circumstances, the effort required to separate out these mixtures makes it undesirable to even attempt recycling the mixture.

If, on the other hand, the label materials happen to have a specific gravity greater than 1.0, certain challenges arise. One such challenge is that the label materials can cause contamination to the PET recyclate when they sink to the bottom of the caustic bath along with the PET article. This is especially a concern for labels including PVC and PETG. In addition, the ink components attached to those dense label materials can further impact recyclate quality.

In the past, there have been shrink sleeve labels formed from PET, which thus could be capable of entering a recycle stream along with the PET article to which they have been affixed. However, there are still further issues that have stunted the implementation of this technology. First, while the label itself may be PET, the label also typically includes inks that may not be compatible with the recycle stream. Thus, a PET label may, in some instances, actually serve to contaminate the recycle stream that includes the article itself. Additionally, some shrink sleeve labels—and other label types (e.g., pressure-sensitive labels, wrap-around labels, etc.) —include adhesives that may also contaminate any recycle stream.

Moreover, there are problems inherent to the method of applying the shrink sleeve label to an article made of PET. One problem that arises with shrink sleeve labelling methods, even those using labelling materials that can be collected as recycled PET, is that shrink sleeve labelling method is more costly than alternative labelling methods. Acquiring the equipment necessary to heat the shrink sleeve film can be prohibitively expensive.

Another type of label that can be affixed to articles made of PET is a wrap-around label. The process of affixing a wrap-around label to an article made of PET involves sizing a label to correspond with a circumference or a perimeter of an article. Then, the wrap-around label is applied to the circumference or the perimeter of the article using an adhesive to bind the label to the article. Another example of a type of label that can be affixed to articles made of PET is a pressure-sensitive label (PSL). However, one problem that arises with conventional wrap-around labels and pressure-sensitive labels is that the low density conventional label materials float to the top of the hot caustic bath sink-float recycling process outlined above. If the labels are affixed to the article made out of PET when subjected to the hot caustic bath sink-float recycling step, then the mixture of materials that float to the top are generally not worth recycling and become waste. Even if the labels were removed prior to recycling the article made out of PET, this additional sorting step simply moves the bottleneck to an earlier point in the recycling process. In either case, the increased difficulty in recycling conventional wrap-around labels results in reduced efficiency in the recycling process and decreased circularity of the conventional wrap-around labels.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

As described above, current methods of recycling various labels (e.g., wrap-around labels and pressure-sensitive labels) exhibit certain drawbacks. For example, conventional wrap-around labels—which are typically made of PP and have comparatively low production costs—cannot be collected as recycled PET, and so must be separated from the PET article and recycling stream. They then typically mix together with various other label materials, resulting in a mixture of materials that are undesirable to separate and recycle individually. Similar issues are present with pressure-sensitive labels.

Aspects of the present invention provide a label or labels that overcome the drawbacks described above. To that end, one particular aspect of the invention provides a label including at least one recyclable layer, the recyclable layer including a label substrate that is compatible with the article to which it is affixed, a washable ink that can be removed from the label in a wash step or a caustic bath, and an adhesive that is configured to dissolve or disperse into a wash step or a caustic bath. As a result, the label may be recycled in the same recycle stream as the article to which it is affixed. During processing, the ink can be washed away, and the adhesive dissolved or dispersed, leaving at least the label substrate to proceed into the recycle stream with the article. In various embodiments, the labels may include wrap-around labels or pressure-sensitive labels.

In that regard, one aspect of the present invention provides for a wrap-around label that is configured to include at least a portion that can be collected with recycled PET during recycling. In this aspect of the invention, the wrap-around label includes at least a recyclable layer, an adhesive, and an ink, and is configured to sink to the bottom of a conventional hot caustic bath sink-float recycling step due to having a specific gravity that is greater than 1.0 after removing the ink and adhesive. At least a portion of the wrap-around label is further configured to be recovered as recycled PET along with the article made of PET to which the wrap-around label is configured to be affixed. In various embodiments, the recyclable layer includes a PET material that can be recycled together with the article made out of PET. In certain embodiments, the wrap-around label includes an adhesive that is configured to dissolve or disperse when subjected to at least one of a hot caustic bath sink-float recycling step or a washing step. In some embodiments, the wrap-around label includes an ink that is configured to be removed from the wrap-around label prior to collection as recycled PET.

Another aspect of the invention is directed to a wrap-around label, including a recyclable layer, an adhesive, and an ink, that is configured to sink to the bottom of a hot caustic bath sink-float recycling step. In some embodiments, the recyclable layer includes a recyclable core layer, a recyclable inner layer, and a recyclable outer layer. Typically, the wrap-around label has the adhesive applied during the application to the article made out of PET, but this is not a limitation of this invention. In various embodiments, the recyclable layer includes a PET material that can be recycled together with the article made out of PET. In certain embodiments, the wrap-around label includes an adhesive that is configured to dissolve or disperse when subjected to at least one of a hot caustic bath sink-float recycling step or a washing step. In some embodiments, the wrap-around label includes an ink that is configured to be removed from the wrap-around label prior to collection as recycled PET. In certain embodiments, the recyclable core layer, the recyclable inner layer, and the recyclable outer skin layer include PET materials that can be recycled along with the article made out of PET. Some embodiments of the invention may optionally include a primer layer and a varnish layer. The optional primer layer may be configured to improve binding between the wrap-around label and the ink. The optional varnish layer may be positioned directly above the ink and may be configured to be caustic resistant.

Another aspect of the invention is directed to a multiple ply wrap-around label including a plurality of recyclable layers, a plurality of adhesive layers, and an ink. The multiple ply wrap-around label is configured to sink to the bottom of a hot caustic bath sink-float recycling step. In some embodiments, at least one of the plurality of recyclable layers includes a recyclable core layer, a recyclable inner skin layer, and a recyclable outer skin layer. In some embodiments, the plurality of recyclable layers includes a first recyclable layer and a second recyclable layer and the plurality of adhesive layers includes a first adhesive layer and a second adhesive layer. In some further embodiments, the second adhesive layer is used to bind the first recyclable layer to the second recyclable layer. The plurality of adhesive layers may be configured to dissolve or disperse when subjected to at least one of a hot caustic bath sink-float recycling step or a washing step. In some embodiments, the wrap-around label includes an ink that is configured to be removed from the wrap-around label prior to collection as recycled PET. Some embodiments of the invention may optionally include a primer layer and a varnish layer. The optional primer layer may be configured to improve binding between the wrap-around label and the ink. In some further embodiments, the primer layer is applied to the first recyclable layer and the second adhesive layer is applied to the second recyclable layer. In other further embodiments, the primer layer is applied to the second recyclable layer and the second adhesive layer is applied to the first recyclable layer. The optional varnish layer may be positioned directly above the ink and may be configured to be caustic resistant.

Another aspect of the invention is directed to a pressure-sensitive label construction including (1) a pressure-sensitive label including at least a recyclable layer, a pressure-sensitive adhesive, an ink, and (2) a support portion including at least a liner layer (which is removed during or prior to application of the pressure-sensitive label to the article). The liner layer may include materials that is configured to prevent permanent adhesion of the adhesive layer to the liner layer. The pressure-sensitive label is configured to sink to the bottom of a hot caustic bath sink-float recycling step. In various embodiments, the recyclable layer includes a PET material that can be recycled together with the article made out of PET. In certain embodiments, the pressure-sensitive label includes a pressure-sensitive adhesive that is configured to dissolve or disperse when subjected to at least one of a hot caustic bath sink-float recycling step or a washing step. In some embodiments, the pressure-sensitive label includes an ink that is configured to be removed from the label prior to collection as recycled PET. This aspect of the invention may optionally include a primer layer and a varnish layer. The optional primer layer may be configured to improve binding between the pressure-sensitive label and the ink. The optional varnish layer may be positioned directly above the ink and may be configured to be caustic resistant.

These and other advantages of the application will be apparent to those of skill in the art with reference to the drawings and the detailed description below.

### BRIEF DESCRIPTION OF THE DRAWINGS

The accompanying drawings, which are incorporated in and constitute a part of this specification, illustrate embodiments of the invention and, together with the general description of the invention given above, and the detailed description given below, serve to explain the principles of the invention. Similar reference numerals are used to indicate similar features throughout the various figures of the drawings.

FIG. 1 shows a cross-sectional view of one embodiment of a label.

FIG. 2 shows a cross sectional view of one embodiment of a wrap-around label.

FIG. 3 shows a cross sectional view of another embodiment of a wrap-around label.

FIG. 4 shows a cross sectional view of yet another embodiment of a wrap-around label.

FIG. 5 shows a cross sectional view of one embodiment of a pressure-sensitive label.

FIG. 6 shows a cross sectional view of another embodiment of a pressure-sensitive label.

### DETAILED DESCRIPTION OF EMBODIMENTS OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described above, aspects of the present invention provide a label including a label substrate that is compatible with the article to which it is affixed. The label may also include a washable ink that can be removed from the label in a wash step or a caustic bath, and an adhesive that is configured to dissolve or disperse into a wash step or a caustic bath. As a result, the label may be recycled in the same recycle stream as the article to which it is affixed. During processing, the ink can be washed away, and the adhesive dissolved or dispersed, leaving at least the label substrate to proceed into the recycle stream with the article. The label includes a label substrate that is compatible with the article made of PET during recycling, a washable ink that can be removed from the label in a wash step or a caustic bath recycling step, and an adhesive that is configured to dissolve or disperse when subjected to a wash step or a caustic bath. One embodiment may include a wrap-around label configured to be affixed to an article made of PET, that overcomes the drawbacks described above. Another embodiment of the invention may include a pressure-sensitive label configured to be affixed to an article made of PET, that overcomes the drawbacks described above. Other types of labels that may be used in accordance with the invention include, but are not limited to, in mold labels, cut and stack labels, and shrink sleeve labels.

In that regard, one aspect of the present invention provides for the use of the wrap-around label that is configured to be affixed to with an article made of PET and configured to be collected with recycled PET during recycling. The wrap around label includes a label substrate that is compatible with the article made of PET during recycling. In some embodiments, the wrap-around label includes PET and/or resins designed to be compatible with PET. In certain embodiments, the PET may be crystallized PET (CPET). In some further embodiments, the wrap-around label includes biaxially oriented PET (BOPET). One non-limiting example of such an embodiment is the CPET F-AUU films supplied by FlexFilms USA. In other embodiments, the wrap-around label includes transverse directionally oriented PET (TDO PET). In various even further embodiments, the wrap-around label includes PET produced from recycled PET.

The wrap-around label has a gauge. In some embodiments, the wrap-around label has a gauge greater than or equal to 10 μm and less than or equal to 100 μm. In some further embodiments, the wrap-around label has a gauge greater than or equal to 19 μm and less than or equal to 55 μm. In some further embodiments, the wrap-around label has a gauge greater than or equal to 12 μm and less than or equal to 30 μm. The gauge of the wrap-around label may depend on the article the wrap-around label is applied to.

The wrap-around label also includes an adhesive that is configured to be affixed to the article made of PET. The adhesive is of a chemistry that may dissolve or disperse when subjected to a wash step or a caustic bath. The adhesive may be applied to the wrap-around label at various points including, but not limited to, during production of the wrap-around label, before the label is affixed to the article made of PET, or during the application of the wrap-around label to the article made of PET. In various embodiments, the adhesive is configured to respond to application of pressure. In some further embodiments, the adhesive used is configured to function in a wrap-around label. In some embodiments, a portion of the adhesive is configured to remain affixed to the article made of PET when subjected to a wash step or a hot caustic bath sink-float recycle step. In other embodiments, a portion of the adhesive is configured to remain affixed to the wrap-around label when subjected to a wash step or a hot caustic bath sink-float recycling step. In other embodiments still, that adhesive is configured to wash off of the article made of PET and the wrap-around label during a wash step or a hot caustic bath sink-float recycle step. In various further embodiments, the adhesive is configured to dissolve or disperse into the wash solution. In other further embodiments, the adhesive is configured to dissolve or disperse in the caustic bath solution. In various further embodiments, the adhesive is configured to be both removed from the article made of PET and not redeposited on the recycled PET prior to collection. Non-limiting examples of the adhesive include Euromelt 369 (commercially available under product name Technomelt EM 369) supplied by Henkel Corporation and Clarity (commercially available under product name Clarity® PHL-4155-ZP) supplied by H.B. Fuller Company.

The wrap-around label is configured to be affixed to the article made out of PET using any conventional process for affixing wrap-around labels. In various embodiments, the wrap-around label is configured to be affixed to an article made of PET using a wrapping apparatus. In some embodiments, the wrap-around label is configured to be affixed to a predominantly cylindrical portion of the article made of PET. In some further embodiments, the wrap-around label is configured to be applied to the cylindrical portion of the article made of PET using a roller. In some embodiments, the adhesive is configured to be applied to the wrap-around label. The adhesive may be applied to the wrap-around label when the wrap-around label is applied to the article made of PET. In other embodiments, the adhesive is configured to be applied to the article made of PET. In some further embodiments, the adhesive is configured to be applied to both the wrap-around label and the article made of PET. It is not necessary that the wrap-around label wrap completely around the article. This may occur where the wrap-around label has a length shorter than a perimeter of the article. However, it is also possible that the wrap-around label has a length longer than the perimeter of the article such that a portion of the wrap-around label covers another portion of the label when affixed to the article.

Another aspect of the present invention provides for the use of a washable ink on the wrap-around label. In various embodiments, the ink is used to apply a graphic or text to the wrap-around label. The ink may be applied to the wrap-around label using any conventional printing process, including but not limited to flexographic, rotary screen, lithography, digital, gravure, letterpress, and any combination of conventional printing methods. In some embodiments, the ink is configured to be removed prior to collecting the wrap-around label as recycled PET. Such an embodiment may include a washable ink such as, but not limited to, a washable gravure ink or a washable flexographic ink. Non-limiting examples of the washable ink used include SunSpectro Solvawash GR and SunSpectro Solvawash FL (supplied by Sun Chemical) and Genesis GS gravure inks (supplied by INX International Ink Co.).

It will be recognized by those of ordinary skill in the art that, while an ink is described above and elsewhere herein, labels of the present invention may include multiple inks (such as multiple washable inks). And these inks may be present in one or more layers of the label.

The washable ink may be configured to be removed from the wrap-around label at different points in a recycling process. In various embodiments, the ink is configured to be removed in a washing step prior to a caustic bath. In some further embodiments, the washable ink is removed in a washing step prior to a hot caustic bath sink-float recycling step. In other embodiments, the washable ink is configured to be removed in the hot caustic bath sink-float recycling step. Preferably, the washable ink is configured to be removed from the wrap-around label in a manner such that it is not redeposited on recycled PET prior to collection.

In some embodiments, the wrap-around label includes additional components. For example, the wrap-around label may include a primer layer. The primer layer may include materials that are configured to be reactive with a caustic bath. In some such embodiments, the primer layer is configured to react with a caustic bath such that the primer layer is not collected along with the recycled PET stream. These caustic bath reactive primer layer materials include, but are not limited to, polyvinyl esters, polyacrylates, or other materials with suitable dissolution characteristics when subjected to basic aqueous mediums such as a caustic bath. In other embodiments, the primer layer is configured to react during a wash step such that the primer layer is not collected along with the recycled PET stream. In some embodiments, the primer layer is configured to receive the ink discussed in the various embodiments above. In various further embodiments, the ink applied to the primer layer is configured to be removed in either a caustic bath or a washing step. The primer layer may increase the binding affinity of the ink to the wrap-around label.

In some embodiments, the wrap-around label may further include a coating layer. In some further embodiments, the coating layer may include a varnish. One non-limiting example of a varnish or coating layer which may be used with embodiments of the current invention is SunCure® HG (High Gloss) TL 4098 coating (commercially available under product number RCYFV484098) supplied by Sun Chemical. Other non-limiting examples of a varnish or coating layer that may be used in embodiments of the present invention include BTC 6678 SR and U37860G supplied by ICP Industrial Solutions Group. In some embodiments, the coating layer is configured to function as an overprint varnish of the label. In various embodiments, the coating layer may include a UV acrylate. The varnish or coating used may be solvent based, including but not limited to a solvent gravure varnish. One non-limiting example of such an embodiment is SunSpectro Solvawash GR varnish or SunSpectro Solvawash FL varnish (supplied by Sun Chemical). This varnish is a solvent gravure varnish that is configured to be used together with the SunSpectro Solvawash GR washable ink. In some embodiments, the varnish layer is configured to be resistant to caustic solutions, such as those conventionally used in the caustic bath recycling step. In other embodiments, the coating layer is configured to act as a primer for the ink. In some further embodiments, the ink is better able to bind with the primer coating layer than at least one other layer of the wrap-around label. In various embodiments, the varnish layer is configured to be transparent. In some further embodiments, the varnish layer is configured not to obstruct view of the layer below. In some embodiments, the thickness of the varnish layer is greater than or equal to 50 nm and less than or equal to 10 μm. In other embodiments, the thickness of the varnish layer is greater than or equal to 50 nm and less than or equal to 150 nm. The varnish may be applied as a continuous coating, as a pattern, or in any other conventional method of application.

Pressure-sensitive labels may require additional and different components from wrap-around labels. For example, a pressure-sensitive label may include a pressure-sensitive adhesive. An adhesive is pressure sensitive if, for example, the adhesive is activated by the application of pressure. Pressure-sensitive adhesives may be permanent or removable depending on the intended use of the label and the article. One non-limiting example of a pressure-sensitive adhesive that may be used in the present invention is Adhesive E5802 supplied by Avery Denison (commercially available under product name Avery Dennison Adhesive E5802).

If the pressure-sensitive adhesive is applied by the manufacturer before being obtained by the user, the pressure-sensitive label may include a liner layer. The liner layer is intended to come in contact with the pressure-sensitive adhesive and prevent the adhesion to unintended surfaces prior to application of the pressure-sensitive label. The liner layer may include a material designed to prevent permanent adhesion of the label to the liner layer and preserve the adhesion function of the adhesive. Liner layer materials that may be used to prevent permanent adhesion of the pressure-sensitive adhesive to the liner layer include, by way of example and not limitation, siliconized PET, siliconized paper, or other suitable non-stick materials.

The figures described below are shown in cross-sectional views. As shown, each of the labels include multiple layers. When referring to these depictions, a layer depicted above another layer is configured to be more exterior than the other layer when the wrap-around label is affixed to the article made out of PET. Similarly, a layer depicted below another layer is configured to be more interior than the other layer when the wrap-around label is affixed to the article made out of PET. When a layer is described relative to another layer, the term “between” is understood to mean “in the space separating at least those two other layers, but not necessarily in physical contact with either of those layers.” When a layer is described relative to another layer, the term “above” means “configured to be more exterior than at least that other layer, but not necessarily in physical contact with that other layer.” When a layer is described relative to another layer, the term “below” means “configured to be more interior than at least that other layer, but not necessarily in physical contact with that other layer.” When any of the terms “between,” “above,” or “below,” are modified by directly (e.g. directly between), then the layer must be in physical contact with at least a portion of the other layer.

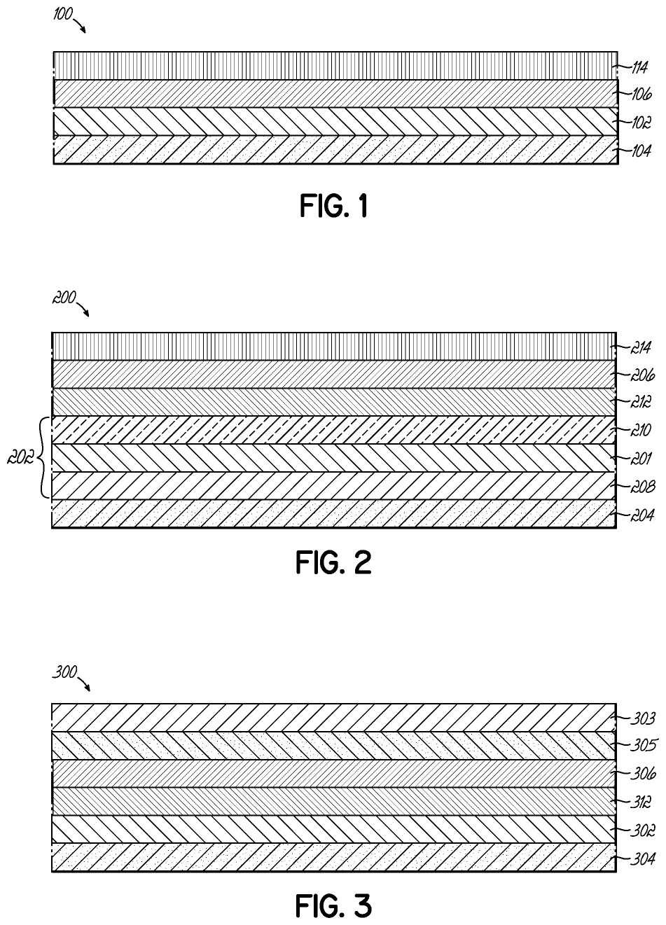

Referring now to FIG. 1, an embodiment of a label 100 in accordance with the principles of the present invention is shown. As shown, the recyclable layer 102 is positioned above an adhesive layer 104 and below an ink layer 106. In this embodiment, a recyclable layer 102 is positioned between an adhesive layer 104 and an ink layer 106. In some further embodiments, the recyclable layer 102 is directly between both the adhesive layer 104 and the ink layer 106. In some embodiments, the adhesive layer 104 is configured to affix the wrap-around label 100 to an article made out of PET (not shown) below the adhesive layer 104. In some embodiments, the adhesive layer 104 is configured to be positioned directly above the article made out of PET. The label 100 may further include an optional varnish layer 114. In some such embodiments, the optional varnish layer 114 is positioned above the ink layer 106. In some further embodiments, the optional varnish layer 114 is positioned directly above the ink layer 106. In other embodiments, the ink layer 106 is configured to be positioned below the recyclable layer 102 and above the optional varnish layer 114 (not shown). In some further embodiments, the ink layer 106 is positioned directly below the recyclable layer 102 and directly above the optional varnish layer 114 (not shown).

The recyclable layer 102 includes a label substrate that is compatible with the article during recycling. In certain embodiments, the article may include PET. In such embodiments, the recyclable layer 102 may include PET or a PET-compatible resin. In some further embodiments, the recyclable layer 102 includes CPET. In these embodiments, the PET or CPET of the recyclable layer 102 may be virgin PET or virgin CPET, or it may be recycled PET or recycled CPET. The PET or CPET included in the recyclable layer 102 may be opaque or clear depending on the embodiment. The recyclable layer 102 may be opaque or clear depending on the embodiment. The recyclable layer 102 may include a recyclable core layer, a recyclable inner skin layer, and/or a recyclable outer skin layer (see discussion of FIG. 2, specifically recyclable layer 202).

The adhesive layer 104 is configured to be removed from the article made out of PET (not shown) and the label 100 during at least one of a wash step or a caustic bath recycling step. The adhesive layer 104 need not be applied to the label 100 during construction. Instead, the adhesive layer 104 may be applied, for example, before the label 100 is affixed to the article made of PET or during the application of the label 100 to the article made of PET. In some embodiments, the adhesive layer 104 is configured to dissolve or disperse when subjected to a caustic bath. The adhesive 104 may react with the caustic bath in a way that improves the ability of the adhesive 104 to dissolve or disperse. In other embodiments, the adhesive 104 is configured to dissolve or disperse during a wash step prior to any caustic bath recycling step. Although the adhesive layer 104 is shown to be a continuous layer completely covering the bottom-most side of the label 100, other embodiments of the invention include an adhesive layer that is only applied to a portion of a label (not shown). In some such embodiments, the adhesive layer is applied to a plurality of discontinuous portions of the label. One non-limiting example of such an embodiment is a label that has a first section of the adhesive layer, that is both applied proximal to a first end of the label and is configured to attach the first end to the article made of PET, and a second section of the adhesive layer, that is both applied proximal to a second end of the label that is opposite to the first end and is discontinuous from the first section of the adhesive layer (not shown). In some further embodiments not shown here, the label is sized so that the second section of the adhesive layer is configured to attach the second end of the label to the upwards facing portion of the first end of the label.

The ink layer 106 is configured to be removed from the article made of PET (not shown) and the wrap-around label 100 during at least one of a wash step or a caustic bath recycling step. In some embodiments, the ink layer 106 is configured to dissolve or disperse when subjected to a caustic bath. In other embodiments, the ink layer 106 is configured to dissolve or disperse during a wash step prior to any caustic bath recycling step.

In some embodiments, the optional varnish layer 114 is configured to be resistant to caustic solutions. In some further embodiments, the optional varnish layer 114 is configured not to be resistant to a caustic solution used in a conventional hot caustic bath sink-float recycling step. In certain embodiments, the optional varnish layer 114 is transparent. In some further embodiments, the transparent optional varnish layer 114 is positioned directly above the ink layer 106 and is configured to not significantly obstruct view of the ink layer 106.

Referring now to FIG. 2, an embodiment of a wrap-around label 200 in accordance with the principles of the present invention is shown. In this embodiment, a recyclable layer 202 is positioned above an adhesive layer 204 and below an ink layer 206. The adhesive layer 204 is configured to affix the wrap-around label 200 to an article made out of PET (not shown) positioned below the adhesive 204. In some embodiments, the adhesive layer 204 is configured to be positioned directly above the article made out of PET.

In the exemplary embodiment, the recyclable layer 202 is made of several constituent layers. The recyclable layer 202 includes a recyclable core layer 201, a recyclable inner skin layer 208, and a recyclable outer skin layer 210. The recyclable inner skin layer 208 is positioned below the recyclable core layer 201. In some embodiments, the inner skin layer 208 is positioned directly below the recyclable core layer 201. The recyclable outer skin layer 210 is positioned above the recyclable core layer 201. In some embodiments, the recyclable outer skin layer 210 is positioned directly above the recyclable core layer 201. In some even further embodiments, the recyclable core layer 201 is positioned directly between the recyclable outer skin layer 210 and the recyclable inner skin layer 208.

In some embodiments, the wrap-around label 200 may further include an optional primer coating layer 212. In some such embodiments, the optional primer coating layer 212 is positioned between the outer skin layer 210 and the ink layer 206. In various further embodiments, the optional primer coating layer 212 is positioned directly between the outer skin layer 210 and the ink layer 206. In some embodiments, the wrap-around label 200 may further include an optional varnish layer 214. In some such embodiments, the optional varnish layer 214 is positioned above the ink layer 206. In some further embodiments, the optional varnish layer 214 is positioned directly above the ink layer 206.

The recyclable layer 202 includes a label substrate that is compatible with the article during recycling. In certain embodiments, the article may include PET. In such embodiments, the recyclable layer 202 may include PET or a PET-compatible resin. In some further embodiments, the recyclable layer 202 includes CPET. In these embodiments, the PET or CPET of the recyclable layer 202 may be virgin PET or virgin CPET, or it may be recycled PET or recycled CPET. The recyclable layer 202 may be opaque or clear depending on the embodiment.

The adhesive layer 204 is configured to be removed from the article made out of PET (not shown) and the wrap-around label 200 during at least one of a wash step or a caustic bath recycling step. The adhesive layer 204 need not be applied to the wrap-around label 200 during construction. Instead, the adhesive layer 204 may be applied, for example, before the wrap-around label 200 is affixed to the article made of PET or during the application of the wrap-around label 200 to the article made of PET. In some embodiments, the adhesive layer 204 is configured to dissolve or disperse when subjected to a caustic bath. The adhesive 204 may react with the caustic bath in a way that improves the ability of the adhesive 204 to dissolve or disperse. In other embodiments, the adhesive 204 is configured to dissolve or disperse during a washing step prior to any caustic bath recycling step. Although the adhesive layer 204 is shown to be a continuous layer completely covering the bottom-most side of the wrap-around label 200, other embodiments of the invention include an adhesive layer that is only applied to a portion of a wrap-around label (not shown). In some such embodiments, the adhesive layer is applied to a plurality of discontinuous portions of the wrap-around label. One non-limiting example of such an embodiment is a wrap-around label that has a first section of the adhesive layer, that is both applied proximal to a first end of the wrap-around label and is configured to attach the first end to the article made of PET, and a second section of the adhesive layer, that is both applied proximal to a second end of the wrap-around label that is opposite to the first end and is discontinuous from the first section of the adhesive layer (not shown). In some further embodiments not shown here, the wrap-around label is sized so that the second section of the adhesive layer is configured to attach the second end of the wrap around label to the upwards facing portion of the first end of the wrap-around label.

The ink layer 206 is configured to be removed from the article made of PET (not shown) and the wrap-around label 200 during at least one of a wash step or a caustic bath recycling step. In some embodiments, the ink layer 206 is configured to dissolve or disperse when subjected to a caustic bath. In other embodiments, the ink 206 is configured to be removed in a wash step prior to any caustic bath recycling step.

The recyclable core layer 201 may be opaque or clear depending on the embodiment. In some embodiments, the recyclable core layer 201 includes recyclable PET. In some further embodiments, the recyclable core layer 201 includes CPET. In other further embodiments, the recyclable core layer 201 includes recycled PET. The PET or CPET included in the recyclable core layer 201 may be opaque or clear depending on the embodiment. In some embodiments, the recyclable core layer 201 may include the same materials as the other layers of recyclable layer 202.)

The inner skin layer 208 may be opaque or clear depending on the embodiment. In some embodiments, the inner skin layer 208 includes recyclable PET. In some further embodiments, the inner skin layer 208 includes CPET. In other further embodiments, the inner skin layer 208 includes recycled PET. The PET or CPET included in the inner skin layer 208 may be opaque or clear depending on the embodiment. In some embodiments, the inner skin layer 208 may include the same materials as the other layers of recyclable layer 202.

The outer skin layer 210 may be opaque or clear depending on the embodiment. In some embodiments, the outer skin layer 210 includes recyclable PET. In some further embodiments, the outer skin layer 210 includes CPET. In other further embodiments, the outer skin layer 210 includes recycled PET. The PET or CPET included in the outer skin layer 210 may be opaque or clear depending on the embodiment. In some embodiments, the outer skin layer 210 may include the same materials as the other layers of recyclable layer 202.

The optional primer coating layer 212 may include a material configured to react with a caustic bath, including but not limited to polyvinyl esters, polyacrylates, or other materials with suitable dissolution characteristics when subjected to basic aqueous mediums such as a caustic bath. In some further embodiments, the optional primer coating layer 212 is configured to dissolve when subjected to a caustic bath. In some embodiments, the optional primer coating layer 212 includes materials that are configured to releasably bind with the ink 206. In some further embodiments, the optional primer coating layer 212 is included so that the ink 206 is better able to bind with the wrap-around label 200.

In some embodiments, the optional varnish layer 214 is configured to be resistant to caustic solutions. In some further embodiments, the optional varnish layer 214 is configured to be resistant to a caustic solution used in a conventional hot caustic bath sink-float recycling step. In certain embodiments, the optional varnish layer 214 is transparent. In some further embodiments, the transparent optional varnish layer 214 is positioned directly above the ink layer 206 and is configured to not significantly obstruct view of the ink layer 206.

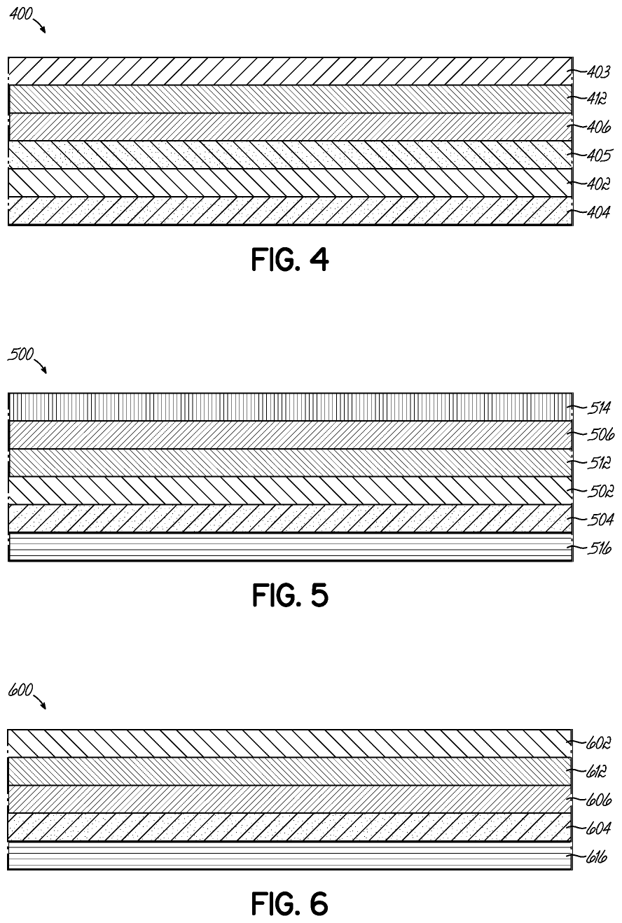

Referring now to FIGS. 3 and 4, embodiments of a two-ply wrap-around label 300 or 400 in accordance with the present invention are shown. With reference to FIG. 3, the wrap-around label 300 includes a first recyclable layer 302 that is positioned above a first adhesive layer 304 and below an ink layer 306. The adhesive layer 304 is configured to affix the wrap-around label 300 to an article made out of PET (not shown) positioned below the adhesive 304. In some embodiments, the adhesive layer 304 is configured to be positioned directly above the article made out of PET. The wrap-around label 300 further includes a second recyclable layer 303 that is positioned above a second adhesive layer 305. In some embodiments, the second recyclable layer 303 is positioned directly above the second adhesive layer 305.

In some embodiments, the wrap-around label 300 may further include an optional primer coating layer 312. As shown, the optional primer coating layer 312 is positioned directly below the ink layer 306. In various further embodiments, the optional primer coating layer 312 is positioned directly between the recyclable layer 302 and the ink layer 306. In some even further embodiments, the optional primer layer 312 is applied to the top facing surface of the first recyclable layer 302, and the ink layer 306 is applied to the top facing surface of the optional primer layer 312.

The first recyclable layer 302 includes a label substrate that is compatible with the article made of PET during recycling. In certain embodiments, the article may include PET. In such embodiments, the first recyclable layer 302 may include PET or a PET-compatible resin. In some further embodiments, the first recyclable layer 302 includes CPET. In these embodiments, the PET or CPET of the first recyclable layer 302 may be virgin PET or virgin CPET, or it may be recycled PET or recycled CPET. The first recyclable layer 302 may be opaque or clear depending on the embodiment. The first recyclable layer 302 may include a recyclable core layer, a recyclable inner skin layer, and/or a recyclable outer skin layer (see discussion of FIG. 2, specifically recyclable layer 202).

The first adhesive layer 304 is configured to be removed from the article made out of PET (not shown) and the wrap-around label 300 during at least one of a wash step or a caustic bath recycling step. The first adhesive layer 304 need not be applied to the wrap-around label 300 during construction. Instead, the first adhesive layer 304 may be applied, for example, before the wrap-around label 300 is affixed to the article made of PET or during the application of the wrap-around label 300 to the article made of PET. In some embodiments, the first adhesive layer 304 is configured to dissolve or disperse when subjected to a caustic bath. The first adhesive layer 304 may react with the caustic bath in a way that improves the ability of the first adhesive layer 304 to dissolve or disperse. In other embodiments, the first adhesive layer 304 is configured to dissolve or disperse during a wash step prior to any caustic bath recycling step. Although the first adhesive layer 304 is shown to be a continuous layer completely covering the bottom-most side of the wrap-around label 300, other embodiments of the invention include a first adhesive layer that is only applied to a portion of a wrap-around label (not shown). In some such embodiments, the first adhesive layer is applied to a plurality of discontinuous portions of the wrap-around label. One non-limiting example of such an embodiment is a wrap-around label that has a first section of the first adhesive layer, that is both applied proximal to a first end of the wrap-around label and is configured to attach the first end to the article made of PET, and a second section of the first adhesive layer, that is both applied proximal to a second end of the wrap-around label that is opposite to the first end and is discontinuous from the first section of the first adhesive layer (not shown). In some further embodiments not shown here, the wrap-around label is sized so that the second section of the first adhesive layer is configured to attach the second end of the wrap around label to the upwards facing portion of the first end of the wrap-around label.

The ink layer 306 is configured to be removed from the article made out of PET (not shown) and the wrap-around label 300 during at least one of a wash step or a caustic bath recycling step. In some embodiments, the ink layer 306 is configured to dissolve or disperse when subjected to a caustic bath. In other embodiments, the ink layer 306 is configured to dissolve or disperse during a wash step prior to any caustic bath recycling step.

The second recyclable layer 303 includes a label substrate that is compatible with the article made of PET during recycling. The second recyclable layer 303 may include PET or a PET-compatible resin. In some further embodiments, the second recyclable layer 303 includes CPET. In these embodiments, the PET or CPET of the second recyclable layer 303 may be virgin PET or virgin CPET, or it may be recycled PET or recycled CPET. The second recyclable layer 303 may be opaque or clear depending on the embodiment. In some embodiments, the second recyclable layer 303 is configured to not significantly obstruct view of the ink layer 306. The second recyclable layer 303 may include a recyclable core layer, a recyclable inner skin layer, and/or a recyclable outer skin layer (see discussion of FIG. 2, specifically recyclable layer 202).

The second adhesive layer 305 is configured to be removed from the wrap-around label 300 during at least one of a wash step or a caustic bath recycling step. The second adhesive layer 305 need not be applied to the wrap-around label 300 during construction. Instead, the second adhesive layer 305 may be applied, for example, before the wrap-around label 300 is affixed to the article made of PET or during the application of the wrap-around label 300 to the article made of PET. In some embodiments, the second adhesive layer 305 is configured to dissolve or disperse when subjected to a caustic bath. The second adhesive layer 305 may react with the caustic bath in a way that improves the ability of the second adhesive layer 305 to dissolve or disperse. In other embodiments, the second adhesive layer 305 is configured to dissolve or disperse during a wash step prior to any caustic bath recycling step. Although the second adhesive layer 305 is shown to be a continuous layer completely covering the bottom-most side of the second recyclable layer 303, other embodiments of the invention include a second adhesive layer that is only applied to a portion of a second recyclable layer (not shown). In some such embodiments, the second adhesive layer is applied to a plurality of discontinuous portions of the second recyclable layer. One non-limiting example of such an embodiment is a second recyclable layer that has a first section of the second adhesive layer, that is both applied proximal to a first end of the second recyclable layer and is configured to attach the first end to the remainder of the wrap-around label, and a second section of the second adhesive layer, that is both applied proximal to a second end of the second recyclable layer that is opposite to the first end and is discontinuous from the first section of the second adhesive layer (not shown). In some further embodiments not shown here, the wrap-around label is sized so that the second section of the second adhesive layer is configured to attach the second end of the second recyclable layer to the upwards facing portion of the first end of the second recyclable layer.

The optional primer coating layer 312 may include a material configured to react with a caustic bath, including but not limited to polyvinyl esters, polyacrylates, or other materials with suitable dissolution characteristics when subjected to basic aqueous mediums such as a caustic bath. In some further embodiments, the optional primer coating layer 312 is configured to dissolve when subjected to a caustic bath. In some embodiments, the optional primer coating layer 312 includes materials that are configured to releasably bind with the ink 306. In some further embodiments, the optional primer coating layer 312 is included so that the ink 306 is better able to bind with the wrap-around label 300.

Referring now to FIG. 4, an embodiment of a wrap-around label 400 in accordance with the principles of the present invention is shown. As shown, the wrap-around label 400 includes a first recyclable layer 402 that is positioned above a first adhesive layer 404 and below an ink layer 406. The first adhesive layer 404 is configured to affix the wrap-around label 400 to an article made out of PET (not shown) positioned below the adhesive 404. In some embodiments, the first adhesive layer 404 is configured to be positioned directly above the article made out of PET. The wrap-around label 400 further includes a second recyclable layer 403 that is positioned above a second adhesive layer 405. However, unlike the wrap-around label 300, the second recyclable layer 403 is not positioned directly above the second adhesive layer 405. Instead, the second adhesive layer 405 is positioned directly above the first recyclable layer 402.

In some embodiments, the wrap-around label 400 may further include an optional primer coating layer 412. As shown, the optional primer coating layer 412 is positioned directly above the ink layer 406. In various further embodiments, the optional primer coating layer 412 is positioned directly between the second recyclable layer 403 and the ink layer 406. In some even further embodiments, the optional primer layer 412 is applied to the bottom facing surface of the second recyclable layer 403, and the ink layer 406 is applied to the bottom facing surface of the optional primer layer 412.

The first recyclable layer 402 includes a label substrate that is compatible with the article made of PET during recycling. In certain embodiments, the article may include PET. In such embodiments, the first recyclable layer 402 may include PET or a PET-compatible resin. In some further embodiments, the first recyclable layer 402 includes CPET. In these embodiments, the PET or CPET of the first recyclable layer 402 may be virgin PET or virgin CPET, or it may be recycled PET or recycled CPET. The first recyclable layer 402 may be opaque or clear depending on the embodiment. The first recyclable layer 402 may include a recyclable core layer, a recyclable inner skin layer, and/or a recyclable outer skin layer (see discussion of FIG. 2, specifically recyclable layer 202).

The first adhesive layer 404 is configured to be removed from the article made out of PET (not shown) and the wrap-around label 400 during at least one of a wash step or a caustic bath recycling step. The first adhesive layer 404 need not be applied to the wrap-around label 400 during construction. Instead, the first adhesive layer 404 may be applied, for example, before the wrap-around label 400 is affixed to the article made of PET or during the application of the wrap-around label 400 to the article made of PET. In some embodiments, the first adhesive layer 404 is configured to dissolve or disperse when subjected to a caustic bath. The first adhesive layer 404 may react with the caustic bath in a way that improves the ability of the first adhesive layer 404 to dissolve or disperse. In other embodiments, the first adhesive layer 404 is configured to dissolve or disperse during a wash step prior to any caustic bath recycling step. Although the first adhesive layer 404 is shown in the embodiment of FIG. 4 to be a continuous layer completely covering the bottom-most side of the wrap-around label 400, other embodiments of the invention (not shown) include an adhesive layer that is only applied to a portion of a wrap-around label. In some such embodiments, the adhesive layer is applied to a plurality of discontinuous portions of the wrap-around label. One non-limiting example of such an embodiment is a wrap-around label that has a first section of the first adhesive layer, that is both applied proximal to a first end of the wrap-around label and is configured to attach the first end to the article made of PET, and a second section of the first adhesive layer, that is both applied proximal to a second end of the wrap-around label that is opposite to the first end and is discontinuous from the first section of the first adhesive layer (not shown). In some further embodiments not shown here, the wrap-around label is sized so that the second section of the first adhesive layer is configured to attach the second end of the wrap around label to the upwards facing portion of the first end of the wrap-around label.

The ink layer 406 is configured to be removed from the article made out of PET (not shown) and the wrap-around label 400 during at least one of a wash step or a caustic bath recycling step. In some embodiments, the ink layer 406 is configured to dissolve or disperse when subjected to a caustic bath. In other embodiments, the ink layer 406 is configured to dissolve or disperse during a wash step prior to any caustic bath recycling step.

The second recyclable layer 403 includes a label substrate that is compatible with the article made of PET during recycling. The second recyclable layer 403 may include PET or a PET-compatible resin. In some further embodiments, the second recyclable layer 403 includes CPET. In these embodiments, the PET or CPET of the second recyclable layer 403 may be virgin PET or virgin CPET, or it may be recycled PET or recycled CPET. The second recyclable layer 403 may be opaque or clear depending on the embodiment. In some embodiments, the second recyclable layer 403 is configured to not significantly obstruct view of the ink layer 406. The second recyclable layer 403 may include a recyclable core layer, a recyclable inner skin layer, and/or a recyclable outer skin layer (see discussion of FIG. 2, specifically recyclable layer 202).

The second adhesive layer 405 is configured to be removed from the wrap-around label 400 during at least one of a wash step or a caustic bath recycling step. The second adhesive layer 405 need not be applied to the wrap-around label 400 during construction. Instead, the second adhesive layer 405 may be applied, for example, before the wrap-around label 400 is affixed to the article made of PET or during the application of the wrap-around label 400 to the article made of PET. In some embodiments, the second adhesive layer 405 is configured to dissolve or disperse when subjected to a caustic bath. The second adhesive layer 405 may react with the caustic bath in a way that improves the ability of the second adhesive layer 405 to dissolve or disperse. In other embodiments, the second adhesive layer 405 is configured to dissolve or disperse during a wash step prior to any caustic bath recycling step. Although the second adhesive layer 405 is shown to be a continuous layer completely covering the upper-most side of the first recyclable layer 402, other embodiments of the invention include a second adhesive layer that is only applied to a portion of the first recyclable layer (not shown). In some such embodiments, the second adhesive layer is applied to a plurality of discontinuous portions of the first recyclable layer. One non-limiting example of such an embodiment is a first recyclable layer that has a first section of the second adhesive layer, that is both applied proximal to a first end of the first recyclable layer and is configured to attach the first end to the remainder of the wrap-around label, and a second section of the second adhesive layer, that is both applied proximal to a second end of the first recyclable layer that is opposite to the first end and is discontinuous from the first section of the second adhesive layer (not shown). In some further embodiments not shown here, the wrap-around label is sized so that the second section of the second adhesive layer is configured to attach the second end of the first recyclable layer to the bottom facing portion of the first end of the first recyclable layer.

The optional primer coating layer 412 may include a material configured to react with a caustic bath, including but not limited to polyvinyl esters, polyacrylates, or other materials with suitable dissolution characteristics when subjected to basic aqueous mediums such as a caustic bath. In some further embodiments, the optional primer coating layer 412 is configured to dissolve when subjected to a caustic bath. In some embodiments, the optional primer coating layer 412 includes materials that are configured to releasably bind with the ink 406. In some further embodiments, the optional primer coating layer 412 is included so that the ink 406 is better able to bind with the wrap-around label 400.

Referring now to FIGS. 5 and 6, embodiments of the label may include a pressure-sensitive label. Referring now to FIG. 5, an embodiment of a pressure-sensitive label 500 in accordance with the principles of the present invention is shown. In this embodiment, a recyclable layer 502 is positioned above a pressure-sensitive adhesive layer 504 and below an ink layer 506. Further, as shown in FIG. 5, the pressure-sensitive adhesive layer 504 is positioned between recyclable layer 502 and a liner layer 516 (which may be constructed of a liner material or liner materials). The liner layer 516 is configured to be removed and discarded before the pressure-sensitive label 500 is applied to the article made of PET so that the pressure-sensitive adhesive 504 is able to affix the pressure-sensitive label 500 to the article made of PET (not shown).

In the embodiment of FIG. 5, the label 500 further includes an optional primer coating layer 512. In the illustrated embodiment, the primer coating layer 512 is positioned between the recyclable layer 502 and the ink layer 506. In various further embodiments, the primer coating layer 512 is positioned directly between the recyclable layer 502 and the ink layer 506. However, this primer layer 512 may be optional, such that in alternate embodiments, the ink layer 506 is positioned directly above recyclable layer 502.

In the illustrated embodiment, the label 500 further includes an optional varnish layer 514. In this embodiment, the varnish layer 514 is positioned above the ink layer 506. In some further embodiments, the optional varnish layer 514 is positioned directly above the ink layer 506. However, this vanish layer may be optional, such that in alternate embodiments, there is no varnish layer adjacent the ink layer.

The recyclable layer 502 includes a label substrate that is compatible with the article made of PET during recycling. In certain embodiments, the article may include PET. In such embodiments, the recyclable layer 502 may include PET or a PET-compatible resin. In some further embodiments, the recyclable layer 502 includes CPET. In these embodiments, the PET or CPET of the recyclable layer 502 may be virgin PET or virgin CPET, or it may be recycled PET or recycled CPET. The recyclable layer 502 may be opaque or clear depending on the embodiment. The recyclable layer 502 may include a recyclable core layer, a recyclable inner skin layer, and/or a recyclable outer skin layer (see discussion of FIG. 2, specifically recyclable layer 202).

The pressure-sensitive adhesive layer 504 is configured to be removed from the article made out of PET (not shown) and the label 500 during at least one of a wash step or a caustic bath recycling step. In some embodiments, the pressure-sensitive adhesive layer 504 is configured to dissolve or disperse when subjected to a caustic bath. The pressure-sensitive adhesive 504 may react with the caustic bath in a way that improves the ability of the pressure-sensitive adhesive 504 to dissolve or disperse. In other embodiments, the pressure-sensitive adhesive 504 is configured to dissolve or disperse during a wash step prior to any caustic bath recycling step. If the pressure-sensitive adhesive 504 is applied prior to application of the pressure-sensitive label 500, the pressure-sensitive adhesive 504 may be directly above the liner layer 516 (discussed further below).

The ink layer 506 is configured to be removed from the article made out of PET (not shown) and the label 500 during at least one of a wash step or a caustic bath recycling step. In some embodiments, the ink layer 506 is configured to dissolve or disperse when subjected to a caustic bath. In other embodiments, the ink 506 is configured to dissolve or disperse during a wash step prior to any caustic bath recycling step.

In some embodiments, the optional primer coating layer 512 includes a material configured to react with a caustic bath, including but not limited to polyvinyl esters, polyacrylates, or other materials with suitable dissolution characteristics when subjected to basic aqueous mediums such as a caustic bath. In some further embodiments, the optional primer coating layer 512 is configured to dissolve or disperse when subjected to a caustic bath. In some embodiments, the optional primer coating layer 512 includes materials that are configured to releasably bind with the ink 506. In some further embodiments, the optional primer coating layer 512 is included so that the ink 506 is better able to bind with the pressure-sensitive label 500.

In some embodiments, the optional varnish layer 514 is configured to be resistant to caustic solutions. In some further embodiments, the optional varnish layer 514 is configured to be resistant to a caustic solution used in a conventional hot caustic bath sink-float recycling step. In certain embodiments, the optional varnish layer 514 is transparent. In some further embodiments, the transparent optional varnish layer 514 is positioned directly above the ink layer 506 and is configured to not significantly obstruct view of the ink layer 514.

In some embodiments, the liner layer 516 may include PET or a PET-compatible resin. In some further embodiments, the liner layer 516 includes siliconized PET. In these embodiments, the PET of the liner layer 516 may be virgin PET or recycled PET. The liner layer 516 may be opaque or clear depending on the embodiment. In other embodiments, the liner layer 516 includes other suitable liner materials such as, by way of example and not limitation, siliconized paper.

Referring now to FIG. 6, an embodiment of a pressure-sensitive label 600 in accordance with the principles of the present invention is shown. In this embodiment, a recyclable layer 602 is positioned above a pressure-sensitive adhesive layer 604 and an ink layer 606. Further, as shown in FIG. 6, the pressure-sensitive adhesive layer 604 is positioned between recyclable layer 602 and a liner layer 616 (which may be constructed of a liner material or liner materials). The liner layer 616 is configured to be removed and discarded before the pressure-sensitive label 600 is applied to the article made of PET so that the pressure-sensitive adhesive 604 is able to affix the pressure-sensitive label 600 to the article made of PET (not shown).

In the embodiment of FIG. 6, the label 600 further includes an optional primer coating layer 612. In the illustrated embodiment, the primer coating layer 612 is positioned between the recyclable layer 602 and the ink layer 606. In various further embodiments, the primer coating layer 612 is positioned directly between the recyclable layer 602 and the ink layer 606. However, this primer layer 612 may be optional, such that in alternate embodiments, the ink layer 606 is positioned directly below the recyclable layer 602.

The recyclable layer 602 includes a label substrate that is compatible with the article made of PET during recycling. In certain embodiments, the article may include PET. In such embodiments, the recyclable layer 602 may include PET or a PET-compatible resin. In some further embodiments, the recyclable layer 602 includes CPET. In these embodiments, the PET or CPET of the recyclable layer 602 may be virgin PET or virgin CPET, or it may be recycled PET or recycled CPET. The recyclable layer 602 may be opaque or clear depending on the embodiment. The recyclable layer 602 may include a recyclable core layer, a recyclable inner skin layer, and/or a recyclable outer skin layer (see discussion of FIG. 2, specifically recyclable layer 202).

The pressure-sensitive adhesive layer 604 is configured to be removed from the article made out of PET (not shown) and the pressure-sensitive label 600 during at least one of a wash step or a caustic bath recycling step. In some embodiments, the pressure-sensitive adhesive layer 604 is configured to dissolve or disperse when subjected to a caustic bath. The pressure-sensitive adhesive 604 may react with the caustic bath in a way that improves the ability of the pressure-sensitive adhesive 604 to dissolve or disperse. In other embodiments, the pressure-sensitive adhesive 604 is configured to dissolve or disperse during a wash step prior to any caustic bath recycling step. If the pressure-sensitive adhesive 604 is applied prior to application of the pressure-sensitive label 600, the pressure-sensitive adhesive 604 may be directly above the liner layer 616 (discussed further below).

The ink layer 606 is configured to be removed from the article made out of PET (not shown) and the label 600 during at least one of a wash step or a caustic bath recycling step. In some embodiments, the ink layer 606 is configured to dissolve or disperse when subjected to a caustic bath. In other embodiments, the ink 606 is configured to dissolve or disperse during a wash step prior to any caustic bath recycling step.

In some embodiments, the optional primer coating layer 612 includes a material configured to react with a caustic bath, including but not limited to polyvinyl esters, polyacrylates, or other materials with suitable dissolution characteristics when subjected to basic aqueous mediums such as a caustic bath. In some further embodiments, the optional primer coating layer 612 is configured to dissolve or disperse when subjected to a caustic bath. In some embodiments, the optional primer coating layer 612 includes materials that are configured to releasably bind with the ink 606. In some further embodiments, the optional primer coating layer 612 is included so that the ink 606 is better able to bind with the label 600.

In some embodiments, the liner layer 616 may include PET or a PET-compatible resin. In these embodiments, the PET of the liner layer 616 may be virgin PET or recycled PET. The liner layer 616 may be opaque or clear depending on the embodiment. In other embodiments, the liner layer includes other suitable liner materials such as, by way of example and not limitation, siliconized paper.

### Example 1

Wrap-around labels (in accordance with principles of the present invention) were prepared, and the labels (and graphics and text provided by the ink) were then tested. In particular, seven tests were performed to see how the wrap-around labels withstood basic testing for existing label technologies.

Materials

Materials used in tested labels include CPET F-AUU, which are 12 μm, 19 μm, and 23 μm crystalized CPET films supplied by FlexFilms USA. The FlexFilms F-AUU films do not have a shrink energy, allowing for their use in wrap-around labels as described below.

Inks tested include the Sun Chemical Solvawash GR, a recycling friendly washable ink that can be removed from the wrap-around label without staining the recycled PET or wash water during the hot caustic bath sink-float separation step.

Methods

Where indicated, the testing procedure outlined was performed to substantially conform with the processes outlined by the American Society for Testing and Materials (ASTM). For example, the process used may have a designation of ASTM D1894-14. In this case, the designated test 1894 was either originally adopted or most recently revised in 2014. Additionally, the most recent year the test was reapproved is indicated by subsequently including the year in parenthesis, for example, ASTM D5264-98 (2019).

APR Ink Bleed Test: Test was conducted with caustic bath, heating plate with magnetic stirring, and spectrophotometer in accordance with guidelines set out by the Association of Plastic Recyclers (APR). The label and PET flakes, which are materials obtained from articles made of PET such as bottles, were stirred together in the caustic bath heated to 85° C. for 15 minutes. After, the caustic bath was allowed to cool to room temperature. Subsequently, the PET flakes were filtrated from the caustic bath and the caustic bath was reserved for observation. The PET flakes were then rinsed with distilled water, dried, then reserved for observation. Testing to assess the PET flakes included transmittance, haze, and clarity of the samples.

Adhesion Tape Test: Test was conducted with 1 inch 600 Adhesive Tape (supplied by 3M) and a 2.2 kg weighted roller. The tape was applied to the sample to evaluate ink adhesion. The tape was rolled two times back and forth with the weighted roller and allowed to dwell on the label for at least 15 seconds. Then, the tape was removed from the label at a moderate speed. Upon removal from sample, the tape and label were inspected for ink/varnish transfer.

Crinkle Test: Test was conducted by hand. Samples were physically compressed (i.e. crinkled) then subsequently visually inspected for defects upon completion of the test.

Dyne Test: Test was conducted with Accu Dyne Test marker pens (supplied by Diversified Enterprises). A marker pen estimated to have a Dyne level slightly lower that that of the sample was chosen and applied to three points on the sample. If the last ink swath remained wetted test sample for three or more seconds, the above process is repeated with the next highest Dyne level pen. If the ink swath beaded up, tore apart, or shrunk into a thin line, the above process was repeated with the next lowest Dyne level pen. The Dyne level of the pen that was best able to allow the ink swath to hold onto the sample for one to three seconds before losing integrity was recorded.

Sutherland Dry Rubs Test: Test was conducted with a chipboard for 500 cycles using a 4 pound weight and ivory board. Samples were tested using the procedure outlined in ASTM D5264-98 (2019). Samples were inspected for defects upon completion of the test.

Static Coefficient of Friction Test: Test was conducted with a drive apparatus including a sled and a plane. Samples were tested using the procedure outlined in ASTM D1894-14. The drive apparatus was configured to apply a force sufficient to cause the sled to move relative to the plane at a speed of 150±30 mm/min when no samples are analyzed. Then, a first sample was applied to the bottom surface of the sled and a second sample was applied to the top surface of the plant such that the first sample would move along the second sample when the force was applied. The force required to cause the first sample to move relative to the second sample was recorded and used to calculate the coefficient of static friction. Samples were inspected for defects after completion of the test.

Kinetic Coefficient of Friction Test: Test was conducted with a drive apparatus including a sled and a plane. Samples were tested using the procedure outlined in ASTM D1894-14. The drive apparatus is configured to apply a force sufficient to cause the sled to move relative to the plane at a speed of 150±30 mm/min when no samples are analyzed. Then, a first sample is applied to the bottom surface of the sled and a second sample is applied to the top surface of the plant such that the first sample will move along the second sample when the force is applied. The average force measured while the first sample moves relative to the second sample was recorded and used to calculate the coefficient of static friction. Samples were inspected for defects after completion of the test.

Discussion

The tests listed above were done to determine the properties of the wrap-around label relevant to recycling. Several samples were created using different graphic layout and application techniques. Labels tested using the methods above matched overall finished design of current product on the market by color and appearance. The wrap-around labels passed the testing listed above. There were no issues with the adhesion tape test, the crinkle test, the Dyne test, the APR Ink Bleed Test, the Sutherland dry rub test, the static coefficient of friction test, or the kinetic coefficient of friction test.

### Example 2

Pressure-sensitive labels (in accordance with principles of the present invention) were prepared, and the labels (and graphics and text provided by the ink) were then tested. In particular, ten tests were performed to see how the wrap-around labels withstood basic testing for existing label technologies.

Materials

Materials used in tested labels include CPET F-AUU, which are 12 μm, 19 μm, and 23 μm crystalized CPET films supplied by FlexFilms USA. The FlexFilms F-AUU films do not have a shrink energy, allowing for their use in pressure-sensitive labels as described below.

Inks tested include the Sun Chemical Solvawash GR, a recycling friendly washable ink that can be removed from the pressure-sensitive label without staining the recycled PET or wash water during the hot caustic bath sink-float separation step.

Adhesives tested include the Avery Dennison Adhesive E5802, a pressure-sensitive adhesive that can be removed from the pressure-sensitive label without staining the recycled PET during the hot caustic bath sink-float separation step.

Methods

Where indicated, the testing procedure outlined was performed to substantially conform with the processes outlined by the American Society for Testing and Materials (ASTM) as explained above.

APR Ink Bleed Test: Test was conducted with caustic bath, heating plate with magnetic stirring, and spectrophotometer in accordance with guidelines set out by the Association of Plastic Recyclers (APR). The label and PET flakes, which are materials obtained from articles made of PET such as bottles, were stirred together in the caustic bath heated to 85° C. for 15 minutes. After, the caustic bath was allowed to cool to room temperature. Subsequently, the PET flakes were filtrated from the caustic bath and the caustic bath was reserved for observation. The PET flakes were then rinsed with distilled water, dried, then reserved for observation. Testing to assess the PET flakes included transmittance, haze, and clarity of the samples.

Adhesion Tape Test: Test was conducted with 1 inch 600 Adhesive Tape (supplied by 3M) and a 2.2 kg weighted roller. The tape was applied to the sample to evaluate ink adhesion. The tape was rolled two times back and forth with the weighted roller and allowed to dwell on the label for at least 15 seconds. Then, the tape was removed from the label at a moderate speed. Upon removal from sample, the tape and label were inspected for ink/varnish transfer.

Crinkle Test: Test was conducted by hand. Samples were physically compressed (i.e. crinkled) then subsequently visually inspected for defects upon completion of the test.

Dyne Test: Test was conducted with Accu Dyne Test marker pens (supplied by Diversified Enterprises). A marker pen estimated to have a Dyne level slightly lower that that of the sample was chosen and applied to three points on the sample. If the last ink swath remained wetted test sample for three or more seconds, the above process is repeated with the next highest Dyne level pen. If the ink swath beaded up, tore apart, or shrunk into a thin line, the above process was repeated with the next lowest Dyne level pen. The Dyne level of the pen that was best able to allow the ink swath to hold onto the sample for one to three seconds before losing integrity was recorded.

Sutherland Dry Rubs Test: Test was conducted with a chipboard for 500 cycles using a 4 pound weight and ivory board. Samples were tested using the procedure outlined in ASTM D5264-98 (2019). Samples were inspected for defects upon completion of the test.

Static Coefficient of Friction Test: Test was conducted with a drive apparatus including a sled and a plane. Samples were tested using the procedure outlined in ASTM D1894-14. The drive apparatus was configured to apply a force sufficient to cause the sled to move relative to the plane at a speed of 150±30 mm/min when no samples are analyzed. Then, a first sample was applied to the bottom surface of the sled and a second sample was applied to the top surface of the plant such that the first sample would move along the second sample when the force was applied. The force required to cause the first sample to move relative to the second sample was recorded and used to calculate the coefficient of static friction. Samples were inspected for defects after completion of the test.

Kinetic Coefficient of Friction Test: Test was conducted with a drive apparatus including a sled and a plane. Samples were tested using the procedure outlined in ASTM D1894-14. The drive apparatus is configured to apply a force sufficient to cause the sled to move relative to the plane at a speed of 150±30 mm/min when no samples are analyzed. Then, a first sample is applied to the bottom surface of the sled and a second sample is applied to the top surface of the plant such that the first sample will move along the second sample when the force is applied. The average force measured while the first sample moves relative to the second sample was recorded and used to calculate the coefficient of static friction. Samples were inspected for defects after completion of the test.

Ice Bath Test: Labels were applied to PET bottles; bottles were filled with water and placed in a cooler full of water and ice. Samples were tested for 72 hours and examined every 24 hours for any label separation and imperfections.

Peel Adhesion Test: Test was conducted using the Avery Dennison Adhesive E5802 adhesive to affix the label to a standard test panel with a controlled pressure. Samples were tested using the procedure laid out in ASTM D3330-04R18, Test Method A. The force required to peel the label from the test panel at a 180 degree angle was recorded.

Accelerated Aging Test: Test was conducted using an oven to subject the multiple samples of pressure-sensitive labels to one of several constant temperatures. Samples were tested using the procedure laid out in ASTM D3045-18. The impact that constant heat applied to the samples has on property retention of the sample overtime was plotted over time to determine the rate of degradation of the sample at room temperature using regression analysis.

Discussion

The tests listed above were done to determine the properties of the pressure-sensitive label relevant to recycling. Several samples were created using different graphic layout and application techniques. Labels tested using the methods above matched overall finished design of current product on the market by color and appearance. The pressure-sensitive labels passed the testing listed above. There were no issues with the adhesion tape test, the crinkle test, the Dyne test, the APR Ink Bleed Test, the Sutherland dry rub test, the static coefficient of friction test, the kinetic coefficient of friction test, the ice bath test, the peel adhesion test, or the accelerated aging test.

While the present invention has been disclosed by reference to the details of preferred embodiments of the invention, it is to be understood that the disclosure is intended as an illustrative rather than in a limiting sense, as it is contemplated that variations and modifications will readily occur to those skilled in the art, within the spirit of the invention and the scope of the appended claims. Notwithstanding the above, certain variations and modifications, while producing less than optimal results, may still produce satisfactory results. All such variations and modifications are intended to be within the scope of the present invention as defined by the claims appended hereto.

What is claimed is:

1. A wrap-around label configured to be recyclable with polyethylene terephthalate (PET) when subjected to a caustic bath recycling process, the wrap-around label comprising:
a recyclable layer that comprises a label substrate that is compatible with PET in a caustic bath recycling process;
an adhesive layer configured to be removable from the wrap-around label in at least one of a wash process or a caustic bath recycling process; and
an ink layer configured to be removable from the wrap-around label in at least one of a wash process or a caustic bath recycling process;
wherein the recyclable layer is positioned between the adhesive layer and the ink layer.

2. The wrap-around label of claim 1, wherein the label substrate comprises crystallized PET (CPET).

3. The wrap-around label of claim 1, wherein the adhesive layer comprises an adhesive that is configured to dissolve or disperse when subjected to at least one of a wash solution or a caustic bath solution.

4. The wrap-around label of claim 1, wherein the ink layer comprises a washable ink configured to dissolve or disperse when subjected to at least one of a wash solution or a caustic bath solution.

5. The wrap-around label of claim 1 further comprising a primer layer that is configured to increase the binding affinity of the ink layer to the label substrate, wherein the primer layer is positioned between the recyclable layer and the ink layer.

6. The wrap-around label of claim 5 wherein the primer layer comprises a material configured to react with a caustic bath solution, wherein the material is selected from the group consisting of polyvinyl esters and polyacrylates.

7. The wrap-around label of claim 1 further comprising a varnish layer, wherein the varnish layer is positioned above the ink layer.

8. The wrap-around label of claim 2 further comprising a second recyclable layer and a second adhesive layer, wherein the second recyclable layer comprises a second label substrate, wherein the second label substrate comprises CPET, and wherein the second adhesive layer is positioned between the recyclable layer and the second recyclable layer.

9. A pressure-sensitive label configured to be recyclable with polyethylene terephthalate (PET) when subjected to a caustic bath recycling process, the pressure-sensitive label comprising:
a recyclable layer that comprises a label substrate that is compatible with PET in a caustic bath recycling process;
a pressure-sensitive adhesive layer configured to be removable from the wrap-around label in at least one of a wash process or a caustic bath recycling process;
an ink layer configured to be removable from the wrap-around label in at least one of a wash process or a caustic bath recycling process;
wherein the recyclable layer is positioned between the adhesive layer and the ink layer.

10. The pressure-sensitive label of claim 9 further comprising a liner layer, wherein the liner layer is positioned below the adhesive layer, and wherein the liner layer is configured to be removed from the pressure-sensitive label before the pressure-sensitive label is applied to an article made of PET.

11. The pressure-sensitive label of claim 9, wherein the label substrate comprises crystallized PET (CPET).

12. The pressure-sensitive label of claim 9, wherein the pressure-sensitive adhesive layer comprises a pressure-sensitive adhesive that is configured to dissolve or disperse when subjected to at least one of a wash solution or a caustic bath solution.

13. The pressure-sensitive label of claim 9, wherein the ink layer comprises a washable ink configured to dissolve or disperse when subjected to at least one of a wash solution or a caustic bath solution.

14. The pressure-sensitive label of claim 9 further comprising a primer layer that is configured to increase the binding affinity of the ink layer to the label substrate, wherein the primer layer is positioned between the recyclable layer and the ink layer.

15. The pressure-sensitive label of claim 14 wherein the primer layer comprises a material configured to react with a caustic bath solution, wherein the material is selected from the group consisting of polyvinyl esters and polyacrylates.

16. The pressure-sensitive label of claim 9 further comprising a varnish layer, wherein the varnish layer is positioned above the ink layer.
